(19) United States
(12) Patent Application Publication
(10) Pub. No.: US 2026/0064842 A1
(43) Pub. Date: Mar. 5, 2026

(54) Detection of Malicious Executable and Linkable Format (ELF) Files

(71) Applicant: Palo Alto Networks, Inc., Santa Clara, CA (US)

(72) Inventors: Tomer Binjamin Hananel, Tel-Aviv (IL); Or Cohen, Tel-Aviv (IL); Yohan Hai Guez, Tel-Aviv (IL); Guy Holdengreber, Tel-Aviv (IL); Roded Zats, Rehovot (IL); Lior Pery, Beer Sheva (IL)

(21) Appl. No.: 18/818,655

(22) Filed: Aug. 29, 2024

(51) Int. Cl. G06F 21/56; G06F 21/55

(52) U.S. Cl. CPC G06F 21/565; G06F 21/554; G06F 2221/033

(57) ABSTRACT

A method for cyber-security includes receiving an Executable and Linkable Format (ELF) file for analysis, and checking (i) whether the ELF file is corrupted and (ii) whether the ELF file is runnable by an Operating System (OS). Upon finding that the ELF file is corrupted but runnable by the OS, a decision is made that the ELF file is potentially malicious, and a responsive action is initiated.

### FIELD OF THE INVENTION

The present invention relates generally to cyber-security, and particularly to methods and systems for detection of malicious Executable and Linkable Format (ELF) files.

### BACKGROUND OF THE INVENTION

ELF is a file format used for storing executable files, object code, shared libraries and core dumps. ELF is specified, for example, in “Tool Interface Standard (TIS) Executable and Linking Format (ELF) Specification,” Version 1.2, TIS Committee, May 1995. Without proper protection, ELF files can be used for launching cyber-attacks.

### SUMMARY OF THE INVENTION

An embodiment of the present invention that is described herein provides a method for cyber-security. The method includes receiving an Executable and Linkable Format (ELF) file for analysis, and checking (i) whether the ELF file is corrupted and (ii) whether the ELF file is runnable by an Operating System (OS). Upon finding that the ELF file is corrupted but runnable by the OS, a decision is made that the ELF file is potentially malicious, and a responsive action is initiated.

In some embodiments, initiating the responsive action includes forwarding the ELF file for further analysis. In a disclosed embodiment, checking whether the ELF file is corrupted includes attempting to parse the ELF file, and deciding that the ELF file is corrupted in response to failing to parse the ELF file.

In an example embodiment, checking whether the ELF file is runnable includes invoking a software module of the operating system, which decides whether the ELF file is considered runnable. In another embodiment, checking whether the ELF file is runnable includes executing a subset of verifications, drawn from a set of verifications that are performed by a software module of the operating system that decides whether the ELF file is considered runnable.

There is additionally provided, in accordance with an embodiment that is described herein, an apparatus for cyber-security including a memory and one or more processors. The memory is configured to store an Executable and Linkable Format (ELF) file. The one or more processors are configured to check (i) whether the ELF file is corrupted and (ii) whether the ELF file is runnable by an Operating System (OS), and, upon finding that the ELF file is corrupted but runnable by the OS, to decide that the ELF file is potentially malicious and initiate a responsive action.

There is also provided, in accordance with an embodiment that is described herein, a computer software product, the product including a tangible non-transitory computer-readable medium in which program instructions are stored, which instructions, when read by one or more processors, cause the one or more processors to receive an Executable and Linkable Format (ELF) file for analysis, to check (i) whether the ELF file is corrupted and (ii) whether the ELF file is runnable by an Operating System (OS), and, upon finding that the ELF file is corrupted but runnable by the OS, to decide that the ELF file is potentially malicious and initiate a responsive action.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a computer employing protection against malicious ELF files, in accordance with an embodiment of the present invention;

FIG. 2 is a flow chart that schematically illustrates a method for detecting potentially malicious ELF files, in accordance with an embodiment of the present invention; and

FIG. 3 is a diagram illustrating an example of creating a corrupted but runnable ELF file, in accordance with an embodiment of the present invention.

### DETAILED DESCRIPTION OF EMBODIMENTS

### Overview

Embodiments of the present invention that are described herein provide methods and systems for detecting ELF files suspected of being malicious. The embodiments described herein refer to the Linux Operating System (OS), by way of example. The disclosed techniques, however, can be used in other suitable OSs.

The Linux kernel is relatively tolerant with respect to the format-compliance of ELF files. In other words, certain deviations from the specified ELF format (e.g., from the TIS ELF specification cited above) do not prevent the file from being executed by the Linux kernel. In the present context, deviations from the ELF format specification are referred to herein as “corruptions”. The terms “run” and “execute”, in various grammatical forms, e.g., “runnable” and “executable” are used interchangeably. In summary, corrupted ELF files may still be runnable by the Linux OS.

This tolerance of Linux opens the door to possible malicious attacks: Security tools may parse an ELF file in accordance with the ELF specification in order to analyze it. An attacker may intentionally corrupt a malicious ELF file in a manner that prevents a security tool from successfully parsing it, causing the malicious ELF file to evade detection. If such a malicious file is still runnable by the OS, it poses an immediate security risk.

In some embodiments of the present invention, security software (e.g., a security agent running in a computer being protected, or a remote security tool, e.g., cloud-based) receives an ELF file for analysis. The security software checks whether the ELF file is both corrupted and runnable by the OS. If the ELF file is found both corrupted and runnable, the security software decides that the ELF file is potentially malicious and initiates a responsive action. Typically, the suspected ELF file will be forwarded for additional checks.

In an example embodiment, the security software decides that the ELF file is corrupted in response to failing to parse the file. To decide whether the ELF file is runnable, the security software may test the file using a Linux module referred to as “Linux kernel checks”—A suite of verifications that Linux applies to ELF files before executing them.

By detecting ELF files that are corrupted but runnable, the disclosed techniques provide better visibility and granularity for focusing on potentially hazardous files.

### System Description

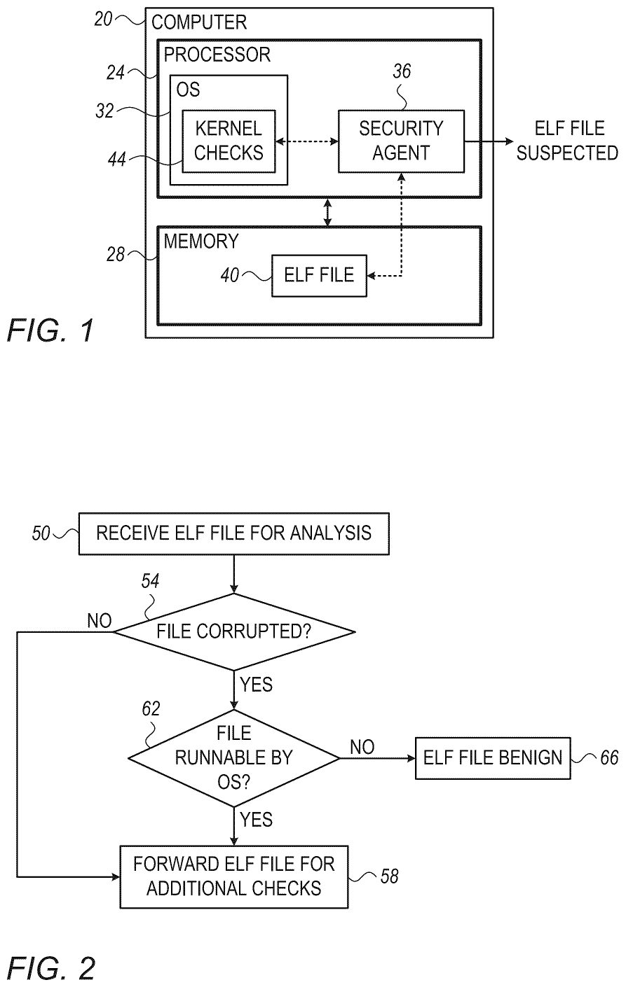

FIG. 1 is a block diagram that schematically illustrates a computer 20 employing protection against malicious ELF files, in accordance with an embodiment of the present invention. Computer 20 comprises a processor 24 and a memory 28. Processor 24 runs an Operating System (OS) 32, in the present example Linux.

In addition, processor 24 runs a security agent 36 that protects computer 20 from various malicious attacks. In particular, agent 36 analyzes ELF files 40 stored in memory 40 and identifies ELF files that are corrupted but runnable by OS 32. For this purpose, in some embodiments, agent 36 accesses a module of OS 32 referred to as a “kernel checks” module 44. Kernel checks module 44 comprises a suite of verifications used by OS 32 to decide whether an ELF file is runnable or not.

Upon detecting an ELF file that is corrupted but runnable, agent 36 outputs an alert indicating that the ELF file is suspected of being malicious. The alert may be sent to and acted upon by a human analyzer and/or by another computerized security tool.

The configuration of computer 20 shown in FIG. 1 is an example configuration, which is chosen purely for the sake of conceptual clarity. In alternative embodiments, any other suitable configuration can be used.

For example, the functions of security agent 36 may be performed by a processor that is external to the computer being protected, e.g., by a remote cloud-based processor. Additionally or alternatively, security agent 36 need not necessarily access the same “security checks” module 44 of the same OS 32 that will later run the ELF file being analyzed. Rather, agent 36 may run a separate replica of the “kernel checks” module that is similar (e.g., identical) in functionality to module 44 of OS 32 but is dedicated for security-related checks. In another embodiment, agent 36 may perform a selected subset of verifications, which drawn from the full set of verifications performed by “kernel checks” module 44 of OS 32.

As another example, the tasks of processor 24 may be split among multiple processors 28.

The various elements of computer 20 may be implemented in hardware, e.g., in one or more Application-Specific Integrated Circuits (ASICs) or FPGAs, in software, or using a combination of hardware and software elements. Memory 28 may comprise any suitable type of memory, e.g., Random-Access Memory (RAM) or disk. Elements that are not necessary for understanding the principles of the present invention have been omitted from the figures for clarity.

Processor or processors 28 may comprise one or more general-purpose processors, which are programmed in software to carry out the functions described herein. The software may be downloaded to any of the processors in electronic form, over a network, for example, or it may, alternatively or additionally, be provided and/or stored on non-transitory tangible media, such as magnetic, optical, or electronic memory.

### Detection of Malicious ELF Files

FIG. 2 is a flow chart that schematically illustrates a method for detecting potentially malicious ELF files, in accordance with an embodiment of the present invention. The method begins with security agent 36 receiving an ELF file 40 for analysis, at a file input stage 50.

At a corruption checking stage 54, agent 36 checks whether the ELF file is corrupted or not, i.e., whether the format of the ELF file complies with the ELF specification. In an example embodiment, agent 36 attempts to parse the ELF file with a parser designed in accordance with the ELF specification. If parsing is successful, agent 36 concludes that the file is not corrupted. If parsing fails, agent 36 decides that the file is corrupted.

If security agent 36 decides that the ELF file is not corrupted, agent 36 forwards the ELF file for additional checks, at a forwarding stage 58. If security agent 36 finds that the ELF file is corrupted, agent 36 proceeds to check whether the ELF file is runnable by OS 32, at a runnability checking stage 62. For example, agent 36 may invoke kernel checks module 44 to check the ELF file.

If security agent 36 decides, based on the verification results provided by kernel checks module 44, that the ELF file is not runnable, the method terminates at a benign termination stage 66.

If, on the other hand, the verification results provided by kernel checks module 44 indicate that the ELF file is runnable, agent 36 concludes that the ELF file is suspected of being malicious, and forwards the ELF file for additional checks at forwarding stage 58. In addition to forwarding the ELF file for further analysis, agent 36 may alert a user, and/or initiate any other suitable action.

The flow of FIG. 2 is an example flow that is depicted purely for the sake of conceptual clarity. In alternative embodiments, any other suitable flow can be used.

### Examples—Creating a Corrupted but Runnable ELF File

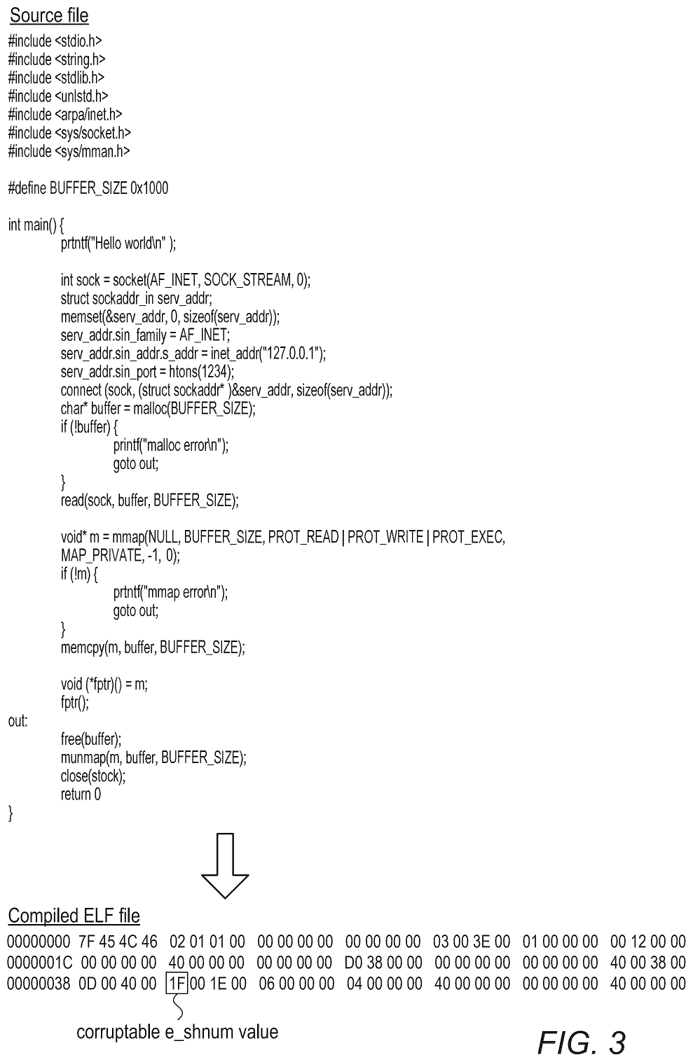

FIG. 3 is a diagram illustrating an example of creating a corrupted but runnable ELF file, in accordance with an embodiment of the present invention. The top of the figure shows the source code of an executable file that gets a buffer from a socket, maps the buffer and executes it. The bottom of the figure shows the compiled ELF file. The format of this file, when produced by a compiler, is a valid ELF file that is expected to comply with the ELF specification. A security product may parse the file and analyze it, e.g., to extract the socket address being accessed.

The compiled ELF file seen at the bottom of FIG. 3 can be corrupted in various ways in a manner that (i) retains the file runnable by the Linux OS and (ii) is likely to cause security tools to fail parsing the file.

For example, according to the ELF specification, an ELF file may comprise one or more sections. Each section has a header. The file may comprise a section header table that describes the section headers. The section header table is defined by several metadata parameters, including the following:
“e_shentsize”—The size of a section header, in bytes. All section headers are of the same size.
“e_shnum”—The number of entries in the section header table. If a file has no section header table, this parameter is set to zero.
“e_shstrndx”—The section header table index of the entry associated with the section name string table. If the file has no section name string table, this parameter is set to “SHN_UNDEF”.
“e_shoff”—The section header table's file offset, in bytes. If a file has no section header table, this parameter is set to zero.

Any of these metadata parameters can be modified in a manner that makes the file corrupted but runnable. For example, the product of e_shentsize and e_shnum gives the total size of the section header table, in bytes. Corrupting either of these parameters causes a discrepancy with the actual section header in the file.

As another example, referring to the example at the bottom of FIG. 3. The e_shnum parameter (which, per the ELF specification, is located at an offset 0X3c from the beginning of the ELF file) has a value of 0x001f. Based on this value, an ELF parser attempting to read the section header table will read 0x001f table entries. Increasing the e_shnum parameter will cause an ELF parser to attempt parsing more than the actual number of entries, and most likely fail.

As yet another example, the e_shoff parameter can be increased to a value that falls outside the file.

As another example, it is possible to corrupt the section table entries themselves. Consider the following structure:
Typedef struct {
   Elf32_Word sh_name;
   Elf32_Word sh_type;
   Elf32_Word sh_flags;
   Elf32_Addr sh_addr;
   Elf32_Off sh_offset;
   Elf32_Word sh_size;
   Elf32_Word sh_link;
   Elf32_Word sh_info;
   Elf32_Word sh_addralign;
   Elf32_Word sh_entsize;
} Elf32_Shdr;

In this structure it is possible to corrupt sh_offset and sh_size to cause the section entry to fall outside the file.

Yet another way to create a corrupted yet runnable ELF file is to follow techniques used by software tools that aim to generate the smallest runnable ELF file possible from an input ELF file. Such software tool may, for example, remove components such as the section table and overlapping entries in the ELF header of the file. The output of such tools is runnable, but typically does not comply with the ELF specification.

Further alternatively, a corrupted but runnable ELF file can be produced in any other suitable way.

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A method for cyber-security, comprising:
receiving an Executable and Linkable Format (ELF) file for analysis;
checking (i) whether the ELF file is corrupted and (ii) whether the ELF file is runnable by an Operating System (OS); and
upon finding that the ELF file is corrupted but runnable by the OS, deciding that the ELF file is potentially malicious and initiating a responsive action.

2. The method according to claim 1, wherein initiating the responsive action comprises forwarding the ELF file for further analysis.

3. The method according to claim 1, wherein checking whether the ELF file is corrupted comprises attempting to parse the ELF file, and deciding that the ELF file is corrupted in response to failing to parse the ELF file.

4. The method according to claim 1, wherein checking whether the ELF file is runnable comprises invoking a software module of the operating system, which decides whether the ELF file is considered runnable.

5. The method according to claim 1, wherein checking whether the ELF file is runnable comprises executing a subset of verifications, drawn from a set of verifications that are performed by a software module of the operating system that decides whether the ELF file is considered runnable.

6. An apparatus for cyber-security, comprising:
a memory, configured to store an Executable and Linkable Format (ELF) file; and
one or more processors, configured to:
check (i) whether the ELF file is corrupted and (ii) whether the ELF file is runnable by an Operating System (OS); and
upon finding that the ELF file is corrupted but runnable by the OS, decide that the ELF file is potentially malicious and initiate a responsive action.

7. The apparatus according to claim 6, wherein, in initiating the responsive action, the one or more processors are configured to forward the ELF file for further analysis.

8. The apparatus according to claim 6, wherein the one or more processors are configured to check whether the ELF file is corrupted by attempting to parse the ELF file, and deciding that the ELF file is corrupted in response to failing to parse the ELF file.

9. The apparatus according to claim 6, wherein the one or more processors are configured to check whether the ELF file is runnable by invoking a software module of the operating system, which decides whether the ELF file is considered runnable.

10. The apparatus according to claim 6, wherein the one or more processors are configured to check whether the ELF file is runnable by executing a subset of verifications, drawn from a set of verifications that are performed by a software module of the operating system that decides whether the ELF file is considered runnable.

11. A computer software product, the product comprising a tangible non-transitory computer-readable medium in which program instructions are stored, which instructions, when read by one or more processors, cause the one or more processors to:
receive an Executable and Linkable Format (ELF) file for analysis;
check (i) whether the ELF file is corrupted and (ii) whether the ELF file is runnable by an Operating System (OS); and
upon finding that the ELF file is corrupted but runnable by the OS, decide that the ELF file is potentially malicious and initiate a responsive action.

12. The product according to claim 11, wherein, in initiating the responsive action, the instructions cause the one or more processors to forward the ELF file for further analysis.

13. The product according to claim 11, wherein the instructions cause the one or more processors to check whether the ELF file is corrupted by attempting to parse the ELF file, and deciding that the ELF file is corrupted in response to failing to parse the ELF file.

14. The product according to claim 11, wherein the instructions cause the one or more processors to check whether the ELF file is runnable by invoking a software module of the operating system, which decides whether the ELF file is considered runnable.

15. The product according to claim 11, wherein the instructions cause the one or more processors to check whether the ELF file is runnable by executing a subset of verifications, drawn from a set of verifications that are performed by a software module of the operating system that decides whether the ELF file is considered runnable.
